(19) United States
(12) Patent Application Publication
(10) Pub. No.: US 2007/0008711 A1
(43) Pub. Date: Jan. 11, 2007

(54) Multifunction lighting and audio system

(75) Inventor: Byung-Chun Kim, Kyunggi-Do (KR)

Correspondence Address: OSTROLENK FABER GERB & SOFFEN, 1180 AVENUE OF THE AMERICAS, NEW YORK, NY, 100368403, US

(73) Assignee: Mox Tronix Co., Ltd.

(21) Appl. No.: 11/249,078

(22) Filed: Oct. 12, 2005

(30) Foreign Application Priority Data
Jul. 11, 2005 (KR) 10-2005-0062173

(51) Int. Cl. H04M 1/22

(52) U.S. Cl. 362/86

(57) ABSTRACT

Disclosed herein is a multifunction lighting and audio apparatus. The apparatus includes a color-music file storage for storing color-music files; an output control unit for controlling the color-music data stored in the color-music file storage so as to separate the color-music data into music signals and color signals, and for producing the separated music signals and color signals; a lighting unit for producing color-lighting based on a color-lighting control signal inputted through the output control unit; an audio unit for producing music based on a music control signal inputted through the output control unit; and an operating unit for operating the above components respectively. It is possible to embody the optimal lighting and audio in which the music and lighting match each other, and to simplify an overall system structure, and decrease the system structure costs without requiring the conventional music parameter detection unit, etc.

### BACKGROUND OF THE INVENTION

1. Field of the Invention

The present invention relates to a multifunction lighting and audio apparatus, and more particularly to a multifunction lighting and audio apparatus, wherein it is possible to simultaneously embody both a lighting system and an audio system.

2. Description of the Related Art

FIG. 1 is a block diagram showing the configuration of a conventional emotional lighting and audio system. This drawing shows the overall configuration of an emotional lighting and audio system disclosed in Korean Patent Laid-open Publication No. 1998-0083350.

As shown in this drawing, the disclosed emotional lighting and audio system includes a general lighting lamp 170 which is arranged on a lighting stand; a CD player 101; a speaker 190; a color filter 180 for changing colors of the lighting lamp 170, a color filter selection unit 181, 182; and an emotional lighting control unit 100 for controlling a brightness of the lighting lamp 170 according to a music parameter extracted based on an audio signal inputted through the CD player 101 or a predetermined program selected automatically in an auto-mode, and producing various colors by selection of the color filter 180.

The emotional lighting control unit 100 includes a music parameter extraction unit 110 for extracting a music parameter in order to control the lighting according to an inputted audio signal; a mode selection button/keyboard 130 for selecting the auto-mode or a plurality of manual-modes, and manipulating other control operations; an emotion database 140 for storing the optimal emotion data acquired by experimentation, wherein the emotion data are information for controlling the lighting-color or the lighting-brightness based on a chord, melody, rhythm or frequency of the music; a control unit 120 reading a brightness control value and a color control value for lighting stored in the emotion database 140, and outputting a brightness control signal and a color control signal, wherein, the control unit 120 controls the lighting according to a predetermined music parameter corresponding to each mode in a case of the manual mode, or according to a music parameter extracted in the music parameter extraction unit 110 in a case of the auto mode, based on the mode selection signal selected by the mode selection button/keyboard 130, respectively; a brightness control unit 150 for controlling a brightness of the lighting lamp 170 based on the brightness control signal of the control unit 120; and a filter control unit 160 for controlling filter selection units 181, 182 so as to select the color filter 180 of the lighting lamp 170 based on the color control signal of the control unit 120.

In the disclosed emotional lighting and audio system, after switching power ON, a user operates the CD player 101 or inputs an external audio signal, and then selects a mode of the emotion lighting. Herein, the user may select any one of the auto mode or the manual mode.

In the case of the manual mode, since the user sets up various modes in advance, the user activates the lighting control program acquired by experimentation according to a type of the music in each mode, and controls the lighting through a predetermined lighting program without extracting a substantially inputted music parameter.

Otherwise, in the case of the auto-mode, by extracting the substantially inputted music parameter, the emotional lighting and audio system searches lighting control data in the emotion database 140 and controls the lighting-brightness and lighting-color based on the extracted music parameter. That is, the emotional lighting and audio system analyses the inputted audio signals, extracts the music parameter, and searches for the corresponding brightness and color control data in the emotion database 140 based on the music parameter so as to control the lighting.

The brightness control is accomplished by controlling a voltage or current of the lighting lamp 170 to acquire a desired brightness.

The color control is accomplished by controlling a step motor 181 through the filter control unit 160 and selecting the color filter 180. Concretely, the emotional lighting and audio system acquires filter location information which represents a location of a color filter to be controlled. Then, after activating the step motor 181, it stops the step motor 181 when the corresponding filter locates at front side of the lighting lamp 170. Thus, the color of the lighting is controlled by locating the filter of the desired color at front side of the lighting lamp 170.

The above operations are controlled according to the corresponding music or according to the program in each mode selected in the manual mode. This is controlled using the database 140 for the music parameter.

However, since the music parameter extraction unit in the disclosed emotional lighting and audio system analyses directly audio signals to control the lighting, the system structure is complex, and costs for forming the music parameter extraction unit are increased.

Particularly, since the disclosed system searches for the corresponding brightness and color control data in the database to control the lighting after extracting the music parameter, the user can use only data stored in the database. Thus, the disclosed system can not realize the lighting appreciate to a new music which is not stored in the database. In addition, even though the music is stored in the database, the disclosed system has a limit to embody the optimal lighting considering to its own characteristics.

### SUMMARY OF THE INVENTION

Therefore, the present invention has been made in view of the above problems, and it is an object of the present invention to provide a multifunction lighting and audio apparatus, wherein, music and a color signal appreciate to the music compose a coded color-music file, and thereby providing an optimized lighting and audio system.

It is another object of the present invention to provide a multifunction lighting and audio apparatus, wherein, color-music data recorded in a color-music file are separated into music signals and color signals through an output control unit in order to embody a respective lighting system and audio system, and thereby it is possible to simplify a overall system structure and to decrease the system structure costs.

In accordance with an aspect of the present invention, the above and other objects can be accomplished by the provision of a multifunction lighting and audio apparatus, the apparatus comprising: a color-music file storage for storing color-music files; an output control unit for controlling the color-music data stored in the color-music file storage so as to separate the color-music data into music signals and color signals, and for producing the separated music signals and color signals; a lighting unit for producing color-lighting based on a color-lighting control signal inputted through the output control unit; an audio unit for producing music based on a music control signal inputted through the output control unit; and an operating unit for operating the above components respectively.

Preferably, the color-music file storage online downloads a database file with both music data and color-lighting data, and stores the file therein.

Preferably, the lighting unit comprises: a light emitting control unit for controlling producing of the color-lighting based on the color-lighting control signal inputted through the output control unit; and a light emitting unit for producing the color-lighting based on a control signal inputted through the light emitting control unit.

Preferably, the lighting unit is formed using a lighting emitting device (LED).

Preferably, the audio unit comprises: an audio control unit for controlling producing of the music based on the signal inputted through the output control unit; and an amplifier and speaker for amplifying and producing the music based on a control signal inputted through the audio control unit.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing the configuration of a conventional emotional lighting and audio system;

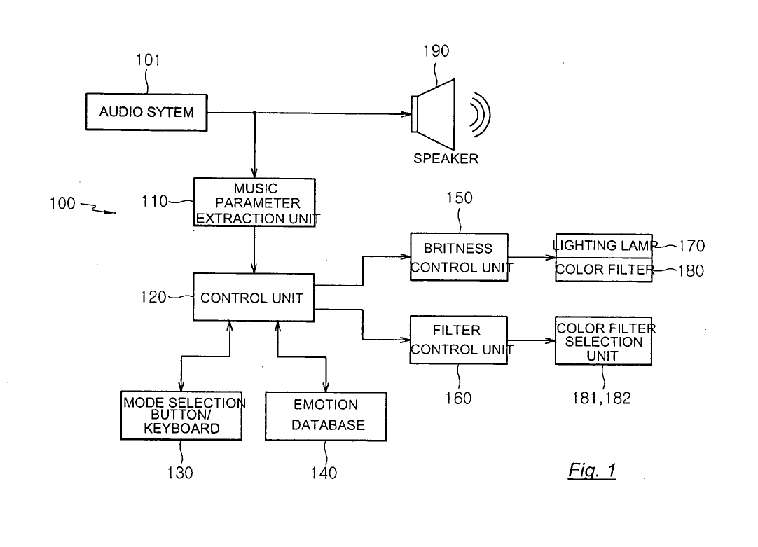

FIG. 2 is a block diagram showing the configuration of a multifunction lighting and audio apparatus according to the present invention;

FIG. 3 is a view illustrating a multifunction lighting and audio apparatus according to a first embodiment of the present invention;

FIG. 4 is a view illustrating a multifunction lighting and audio apparatus according to a second embodiment of the present invention; and

FIG. 5 is a perspective view illustrating a multifunction lighting and audio apparatus according to a third embodiment of the present invention.

### DESCRIPTION OF THE PREFERRED EMBODIMENTS

Now, preferred embodiments of the present invention will be described in detail with reference to the annexed drawings.

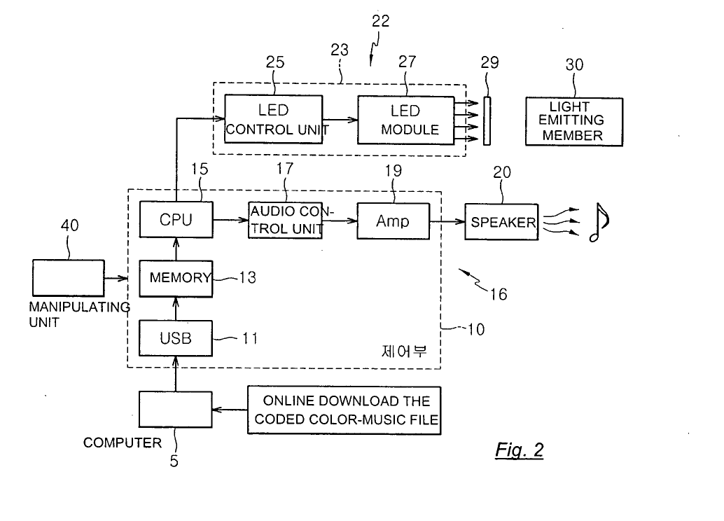

FIG. 2 is a block diagram showing the configuration of a multifunction lighting and audio apparatus according to the present invention.

As shown in this drawing, the multifunction lighting and audio apparatus according to the present invention includes a color-music file storage 13 for storing color-music files; an output control unit 15 for controlling the color-music data stored in the color-music file storage 13 so as to separate the color-music data into music signals and color signals, and for producing the separated music signals and color signals; a lighting unit 22 for producing a color-lighting based on a color-lighting control signal inputted through the output control unit 15; an audio unit 16 for producing music based on a music control signal inputted through the output control unit 15; and a manipulating unit 40 for manipulating the above components respectively.

An explanation of the above components of the multifunction lighting and audio apparatus according to the present invention will be described in detail as follows.

To begin with, the color-music file storage 13 includes a memory, etc. which is online downloaded a database file containing coded music and color-lighting data and stored the database file.

The color-music file storage 13 stores the coded color-music file which is downloaded by a computer 5, in the memory through a universal serial bus (USB) port. Herein, the stored color-music file is stored, corrected, or deleted through the computer 5 or the manipulating unit 40.

In addition, it is preferred that the color-music file is a file in which is stored the music data and the color-lighting data, but it is limited thereto. Additionally, if a music file or a color-lighting file is arranged respectively, the output control unit 15 may incorporate and process the music file and the color-lighting file, and may output the incorporated file.

Next, the output control unit 15 separates the coded color-music data stored in the color-music file storage 13 into music signals and color signals, and outputs the separated music signals and color signals to the lighting unit 22 and the audio unit 16 respectively. Herein, the output control unit 15 may be a typical processing apparatus, for example, a CPU, etc.

Next, the lighting unit 22 includes a light emitting control unit 23 for controlling producing of the color-lighting based on the color-lighting control signal inputted through the output control unit 15; and a light emitting unit 30 for producing the color-lighting based on a control signal inputted through the light emitting control unit 23.

Here, it is preferred that the lighting unit is formed using a lighting emitting device (LED). The light emitting control unit 23 includes an LED control unit 25 for receiving a color signal with red (R), green (G) and blue (B) components from the output control unit 15, and outputting a signal for controlling a light emitting; and an LED module 27 which contains a plurality of R, G and B LEDs, and produces various light emitting with various colors based on the light emitting control signal inputted through the light emitting control unit 23. In addition, a filter 29 and a light emitting member 30 optically devised are arranged at the front side of the LED module 27.

The audio unit 16 includes an audio control unit 17 for controlling producing of the music based on the signal inputted through the output control unit 15; and an amplifier 19 and speaker 20 for amplifying and producing the music based on a control signal inputted through the audio control unit 17.

In addition, the manipulating unit 40 selects the stored color-music file, and embodies the color-music.

Meanwhile, the color-music storage 13, the output control unit 15 and the audio control unit 17 or the like may be incorporated into a control unit 10 as one module.

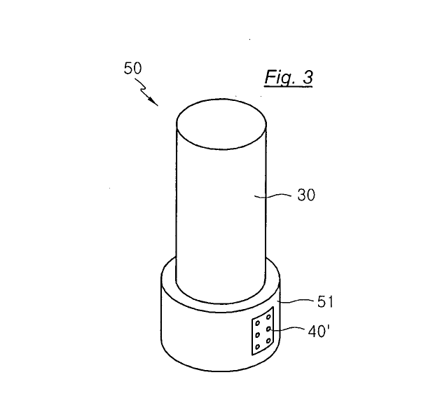

On the other hand, FIGS. 3 to 5 are views illustrating the multifunction lighting and audio apparatus according to various embodiments of the present invention.

FIG. 3 is a view illustrating a multifunction lighting and audio apparatus according to a first embodiment of the present invention.

Referring to FIG. 3, the multifunction lighting and audio apparatus 50 according to the first embodiment of the present invention may be a stand type with a cylindrical structure, which may be primarily divided into a body 51 and a light emitting member 30.

Herein, the color-music storage 13, the output control unit 15 and the audio unit 16 and a manipulating unit 40′ or the like are directly arranged in the body 51. Otherwise, the above components are separately or independently formed, and connected to the body 51.

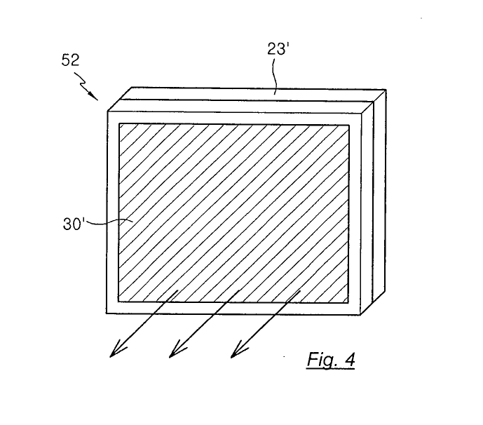

FIG. 4 is a view illustrating a multifunction lighting and audio apparatus according to a second embodiment of the present invention. FIG. 4 illustrates a panel type light emitting member 30′.

Referring to FIG. 4, in the multifunction lighting and audio apparatus 52, a light emitting control unit 23′ is located at a rear side, and the light emitting member 30′ is located at a front side. This panel type of a light emitting member 30′ may incorporate other components of the multifunction lighting and audio apparatus according to the present invention. Otherwise, it may be separately formed and be subsequently connected to other components.

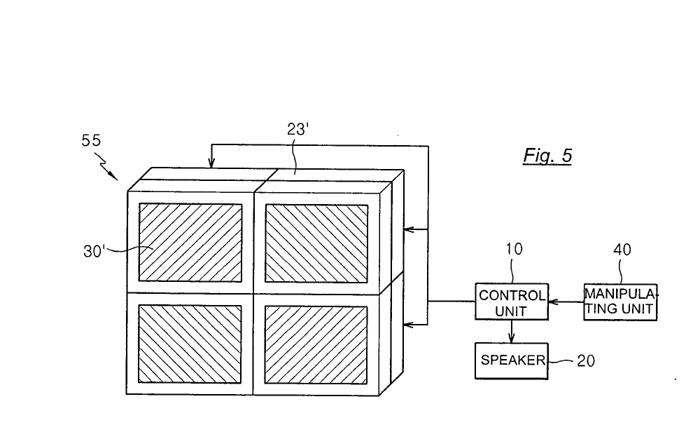

FIG. 5 is a perspective view illustrating a multifunction lighting and audio apparatus according to a third embodiment of the present invention. FIG. 5 illustrates a combination type light emitting member 30′.

Referring to FIG. 5, the multifunction lighting and audio apparatus 55 includes the combination type light emitting member 30′ which is in combination with the panel type light emitting member shown in FIG. 4. The combination type light emitting member 30′ is connected to the manipulating unit 40, the control unit 10, the speaker 20 or the like.

On the other hand, the operations of the multifunction lighting and audio apparatus according to the present invention will be described as follows.

The multifunction lighting and audio apparatus according to the present invention is a system which represents color-music through the light emitting member 30 and the speaker 20. In the case where the lighting and audio apparatus downloads a database file of the color-music, the output control unit 15 in the lighting and audio apparatus separates the downloaded file into a color signal and a music signal, and outputs the color signal to the lighting unit 22, and the music signal to the audio unit 16 to produce the color lighting and the music respectively.

Herein, the color-music is developed to enhance the quality of life for well-being, yoga, meditation and the like. In addition, the color-music is previously composed or additionally developed a coded database which represents both color and music.

In the case where the coded color-music database is previously arranged, the coded color-music file which is downloaded by a computer 5 is stored in the memory through a universal serial bus (USB) port. In addition, a desired color-music is expressed by presetting a program for selectively controlling the stored color-music file.

The stored color-music may be manipulated through the manipulating unit 40, and the coded color-music may be conveniently control by user through the computer 5.

Herein, the color of the coded color-music is an algorithmized color appreciate to the music, that is, a tone, a rhythm, a chord and the like using the three primary colors with red, blue and green color. The color may be expressed by causing R, G and B LED to be respectively or compositely operated through the lighting unit 22.

An example of a file structure for the coded color-music is as follows:

1 (coded color-music file)=color(1′)+music(1″)

2 (coded color-music file)=color(2′)+music(3″)

3 (coded color-music file)=color(3′)+music(3″)

On the other hand, since the multifunction lighting and audio apparatus according to the present invention is based on a 3-color LED with R, G and B colors, a user may basically select a desired color. In addition, since the multifunction lighting and audio apparatus according to the present invention aims to embody a white color as a general lighting color through a 3-color combination, the user may apply it as a general lighting source.

In addition, since the multifunction lighting and audio apparatus according to the present invention can use a downloaded color-music database file, or a color-music file which is previously stored in a memory, it can produce various color-music in any places. In addition, since the multifunction lighting and audio apparatus according to the present invention can produce a file which is incorporated with music data and color-lighting data, and, if need, it can produce the color-music by incorporating and processing each data which are stored in each file.

As apparent from the above description, the present invention provides a multifunction lighting and audio apparatus, wherein, since music and a color signal appreciate to the music compose a coded color-music file, and an output control unit separates from a music signal and the color signal, it is capable of embodying the optimal lighting and audio in which the music and lighting match each other.

In addition, since data recorded in a color-music file are separated from an output control unit, it is capable of simplifying overall system structure and decreasing the system structure costs without requiring the conventional music parameter detection unit, etc.

Thus, since the multifunction lighting and audio apparatus according to the present invention can be applied as a general lighting source and can select a desired color, it has an economic effect comparing with the conventional lighting. In addition, the multifunction lighting and audio apparatus according to the present invention can provide health cares such as fatigue recovery, relaxation or sleeping in a house, public places or the like, and can enhance the quality of life by applying the color-music of various genres to various commercial facilities.

It is another object of the present invention to provide a multifunction lighting and audio apparatus, wherein, color-music data recorded in a color-music file are separated into music signals and color signals through an output control unit in order to embody a respective lighting system and audio system, and thereby it is possible to simplify a overall system structure and to decrease the system structure costs.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A multifunction lighting and audio apparatus, the apparatus comprising:
a color-music file storage for storing color-music files;
an output control unit for controlling the color-music data stored in the color-music file storage so as to separate the color-music data into music signals and color signals, and for producing the separated music signals and color signals;
a lighting unit for producing color-lighting based on a color-lighting control signal inputted through the output control unit;
an audio unit for producing music based on a music control signal inputted through the output control unit; and
an operating unit for operating the above components respectively.

2. The apparatus as set forth in claim 1, wherein the color-music file storage online downloads a database file with both music data and color-lighting data, and stores the file therein.

3. The apparatus as set forth in claim 1, wherein the lighting unit comprises:
a light emitting control unit for controlling producing of the color-lighting based on the color-lighting control signal inputted through the output control unit; and
a light emitting unit for producing the color-lighting based on a control signal inputted through the light emitting control unit.

4. The apparatus as set forth in any one of claims 1 to 3, the lighting unit is formed using a lighting emitting device (LED).

5. The apparatus as set forth in claim 1, wherein the audio unit comprises:
an audio control unit for controlling producing of the music based on the signal inputted through the output control unit; and
an amplifier and speaker for amplifying and producing the music based on a control signal inputted through the audio control unit.
